(19) United States
(12) Patent Application Publication
(10) Pub. No.: US 2006/0266677 A1
(43) Pub. Date: Nov. 30, 2006

(54) Screen assembly having dimples formed in frame sections for retaining a screen cloth and a method of forming the same

(75) Inventors: Don Quinn, Rice Lake, WI (US); Jeff V. Sawyers, Rice Lake, WI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Quanex Corporation

(21) Appl. No.: 11/441,842

(22) Filed: May 26, 2006

Related U.S. Application Data
(60) Provisional application No. 60/685,308, filed on May 27, 2005.

(51) Int. Cl. B07B 1/28

(52) U.S. Cl. 209/315

(57) ABSTRACT

A screen frame assembly for a door or a window includes a plurality of frame sections defining an opening and a screen cloth covering the opening. The frame sections include a first leg folded onto a second leg with the legs defining a slot therebetween. An edge of the screen cloth is disposed in the slot for each of the frame sections. A plurality of dimples are formed in the frame sections to trap and retain the screen cloth to the frame sections.

### CROSS REFERENCE TO RELATED APPLICATION

This application claims the benefit of U.S. provisional patent application Ser. No. 60/685,308, filed May 27, 2005.

### BACKGROUND OF THE INVENTION

1. Field of the Invention

The present invention relates to screen frame assemblies for a window or a door. More specifically, the present invention relates to retention of a screen cloth to frame sections of the screen frame assemblies.

2. Description of the Related Art

Traditional screen assemblies for windows or doors include frame sections which define an opening and a screen cloth covering the opening. These screen assemblies retain a screen cloth to the frame sections utilizing a mechanical fit. The frame sections are formed to define a spline channel. The screen assembly is formed by stretching a screen cloth over at least a portion of the spline channel and pressing a spline into the spline channel, thereby trapping the screen cloth in the spline channel.

Some screen assemblies have been constructed to eliminate the need for the spline channel and spline to trap the screen cloth into place. Instead, these screen assemblies are manufactured by forming corrugations along the frame sections to trap the screen cloth in place. A screen assembly which forms corrugations to trap the screen cloth in place is disclosed in U.S. Pat. No. 882,397 to Limoge (the '397 patent). The '397 patent discloses a screen assembly including a plurality of frame sections. Each frame section is formed from a sheet of metal, folded upon itself. A screen cloth is inserted between the folds. The screen cloth is held in place by forming a continuous corrugated groove along each of the frame sections. The continuous corrugation traps the screen cloth within the folds All of the frame sections and the screen cloth are placed in a die press where the die press forms the corrugation in all of the frame sections at the same time. The strength with which the screen cloth is held to each frame section is dependent upon any spacing which may develop along the single corrugation. Due to the continuity of the corrugation, if a gap develops within the corrugation of the fold and a small portion of the screen cloth becomes loose or dislodged, the entire screen cloth may eventually become dislodged as the screen cloth gets pulled from the continuous corrugation.

Although the type of screen assembly which is disclosed in '397 patent has eliminated the requirement of a spline and a spline channel to secure the screen cloth to the screen frame, the assembly disclosed in the '397 patent reduces the strength of the retention between the screen cloth and the frame section over the use of the spline. While this method of securing the screen cloth to the screen frame reduces the time and expense it takes to manufacture a screen assembly, it also reduces the strength and durability of the screen assembly.

### SUMMARY OF THE INVENTION AND ADVANTAGES

The present invention is a screen assembly for a window or a door. The assembly comprises a plurality of frame sections which define an opening. Each of the frame sections are formed from a strip of material and the strip of material is folded upon itself to include a first leg and a second leg which is adjacent the first leg. The legs define a slot therebetween. A screen cloth is disposed in the slot of each of the frame sections and extends across the opening between the frame sections. A plurality of spaced dimples are formed in the first legs of each of the frame sections. The dimples extend into the slot of each of the frame sections to engage and trap the screen cloth between the dimple of the first leg and the second leg to retain the screen cloth to the frame sections.

The present invention also provides a method of forming the screen assembly. The method comprises the steps of placing an edge of the screen cloth in the cavity of the frame section, collapsing the first leg onto the second leg to define the slot therebetween, and forming the plurality of spaced dimples in the first leg to retain the screen cloth to the frame section.

By forming a plurality of spaced dimples in each of the frame sections, the screen cloth follows the contour of each of the dimples. By following the contour of each of the dimples, the screen cloth is trapped and retained to the frame sections by each of the dimples. Therefore, if the screen cloth happens to become dislodged from one of the dimples, the screen cloth is still retained by each of the other dimples. This means that the screen cloth is securely retained to the frame sections by only using dimples formed in the frame sections such that the screen cloth will not become dislodged from any of the frame sections.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is front view of a screen assembly;

FIG. 2 is a perspective view illustrating a screen cloth being inserted into a frame section of the screen assembly;

FIG. 3 is a perspective view illustrating the screen cloth and the frame section passing between a pair of locking rolls which are forming dimples in the frame sections;

FIG. 4a is a top view of the frame section illustrating the screen cloth retained to the frame section with cubic shaped dimples;

FIG. 4b is a top view of the frame section illustrating the screen cloth retained to the frame section with semi-spherical shaped dimples;

FIG. 5a is a cross sectional side view of the screen cloth disposed within the frame section taken along line 4a-4a with cubic shaped dimples formed through the frame section;

FIG. 5b is a cross sectional side view of the screen cloth disposed within the frame section taken along line 4b-4b with semi-spherical shaped dimples formed through the frame section;

FIG. 6 is a top view illustrating the screen cloth and a first and a second frame section simultaneously passing between pairs of locking rolls which are forming the dimples in the frame sections;

FIG. 7 is a front view of the frame assembly illustrating placing a fourth frame section onto the screen cloth;

FIG. 8 is a top view illustrating the screen cloth including a third and the fourth frame sections disposed perpendicular to the first and second frame sections simultaneously passing between pairs locking rolls which are forming dimples in the frame sections,

FIG. 9 is a perspective view illustrating the screen cloth and the third frame section passing between a pair of locking rolls with ends of the adjacent first and second frame sections disposed in a cavity of the third frame section to form a corner therebetween;

FIG. 10 is a perspective view illustrating the screen cloth and the third frame section passing between a pair of locking rolls with ends of the first and second adjacent frame sections abutting margins of the third frame section to form a butt-joint corner therebetween;

FIG. 11 is a top view of the corner formed in FIG. 9; and

FIG. 12 is a cross sectional view of the corner of FIG. 11 taken along line 12-12.

### DETAILED DESCRIPTION OF THE INVENTION

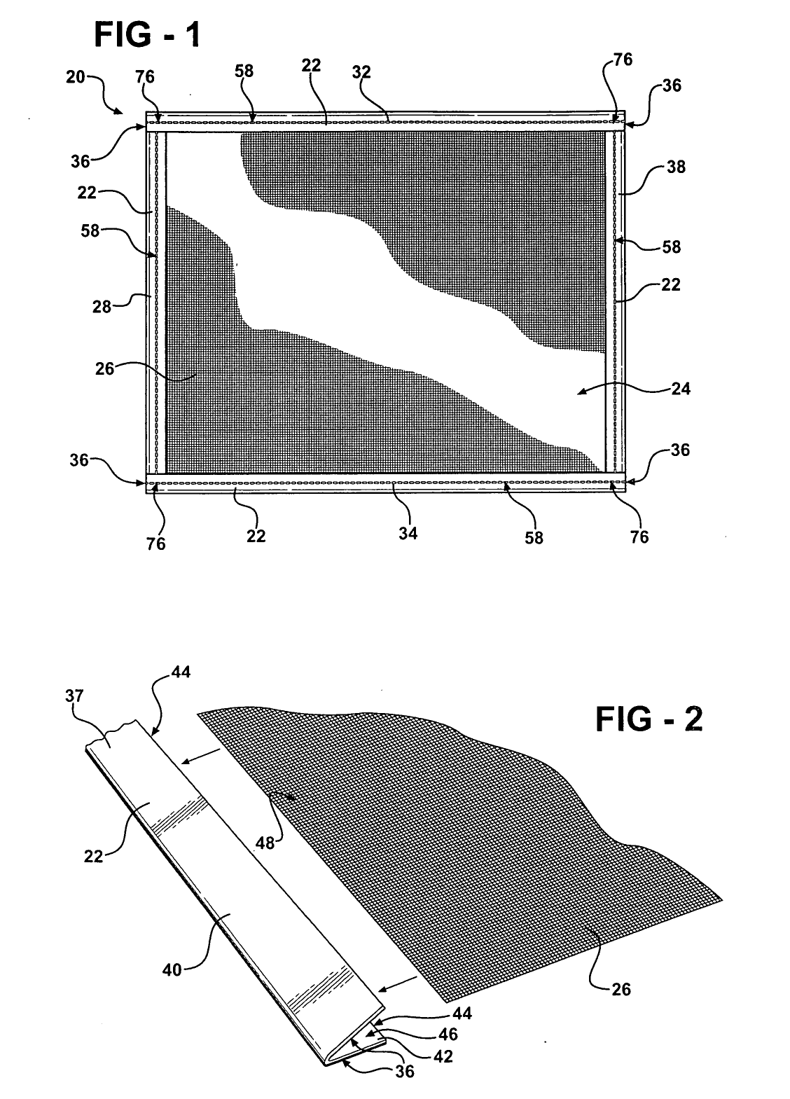

The present invention relates to a screen assembly for a window or a door. The assembly is shown generally at 20 in FIG. 1. The assembly 20 includes a plurality of frame sections 22 defining an opening 24. A screen cloth 26 covers the opening 24.

A typical screen assembly 20 has four frame sections 22, i.e., a first frame section 28, a second frame section 30, a third frame section 32, and a fourth frame section 34. Each frame section extends between ends 36. However, the screen assembly 20 is not limited to having four frame sections 22 and may include any number of desired frame sections. Although the frame sections 22 surround the opening 24, it should be understood that “surrounding” does not require complete enclosure of the perimeter of the opening 24. While the screen assembly 20 can include four frame sections 22 that are connected to form an enclosed rectangular shape surrounding the opening 24, it should be understood that the frame can also include more or less frame sections 22 such as three frame sections 22 that are connected to form a triangular shape, for example, or even three sides of a rectangular shape that surrounds the opening 24. Other configurations of frame sections 22 are also possible. Additionally, the perimeter is not limited to the rectangular shape, but can be any shape that is desired (e.g. triangular, octagonal, etc.).

Each of the frame sections 22 are formed from a strip of material 38, such as a blank. The strip of material 38 is typically formed from aluminum, but any type of material may also be used so long as it is deformable. The strip of material 38 may be pre-painted, although painting is not required. Generally, the strip of material 38 has an elongated rectangular shape. The strip of material 38 is folded upon itself to include a first leg 40 and a second leg 42 adjacent the first leg 40. Each of the legs 40, 42 extend along a margin 44. When the strip of material 38 is initially folded upon itself, the legs 40, 42 define cavity 46 therebetween. Typically, the cavity 46 is V-shaped, but the cavity 46 may be any desired shape. The screen cloth 26 is bounded by edges 48. The edges 48 are determined by the number of frame sections 22 which surround the opening 24. In a four-sided screen assembly 20, for example, the screen cloth 26 has four edges 48, e.g., a first edge 50, a second edge 52, a third edge 54, and a fourth edge 56. Each edge is placed in the cavity 46 of the respective strip of material 38, which has been folded upon itself. The first leg 40 is then collapsed onto the second leg 42 to close the cavity 46 and define a slot 57 therebetween.

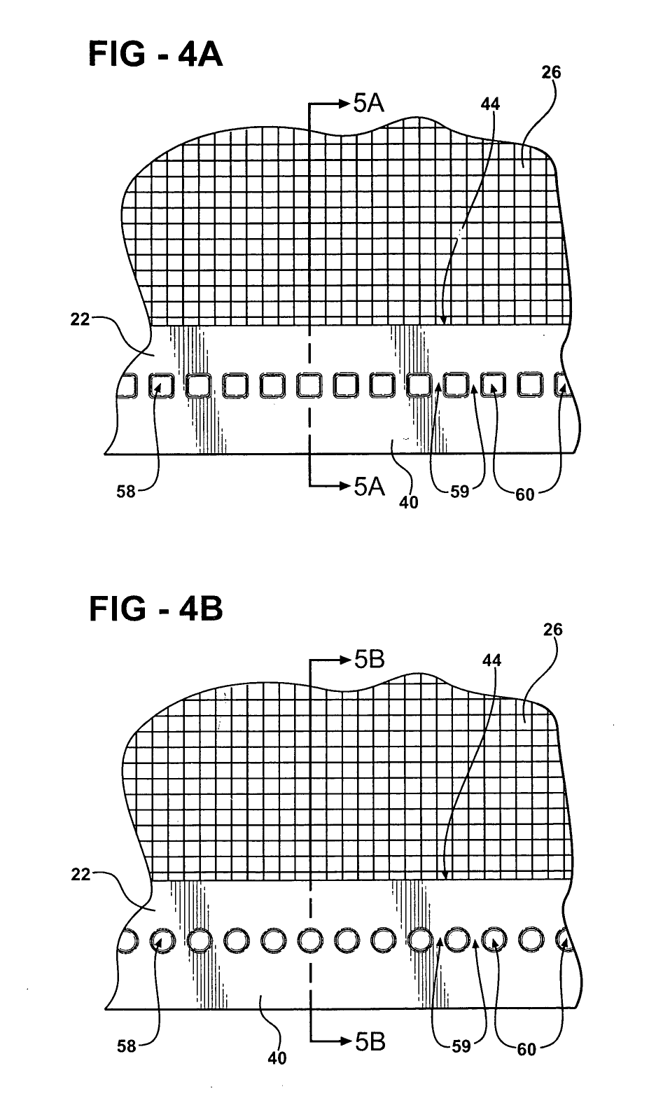

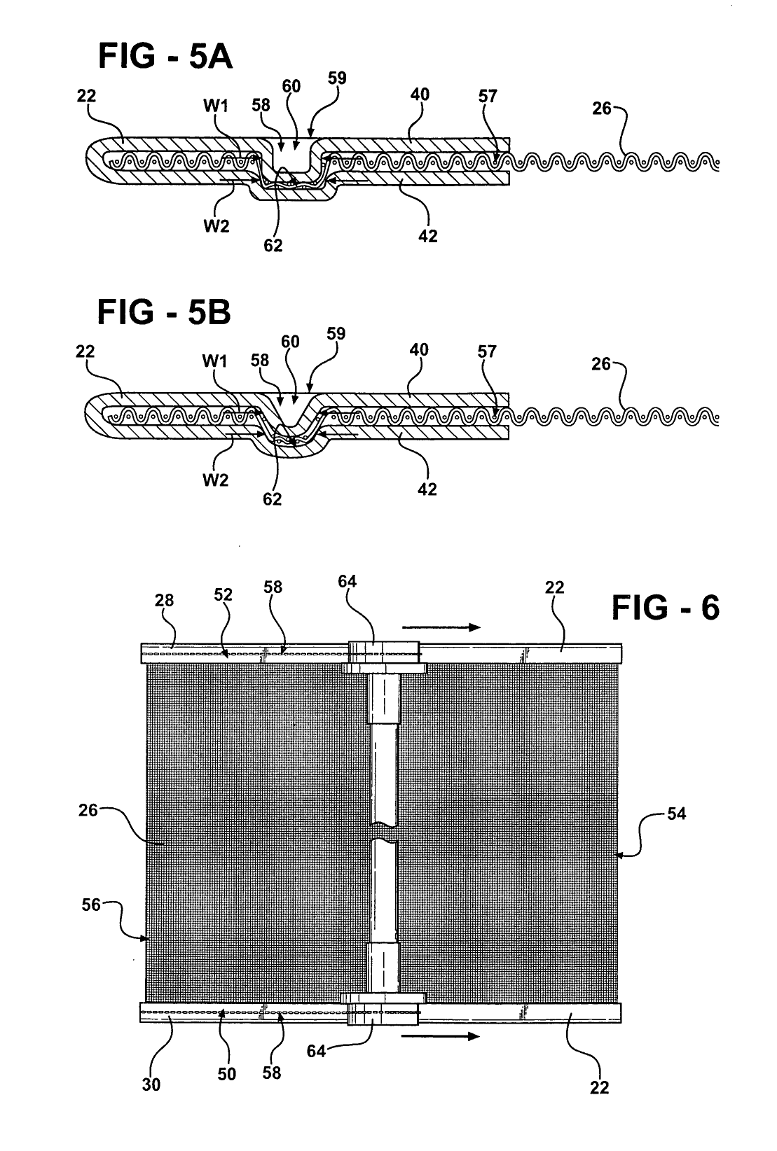

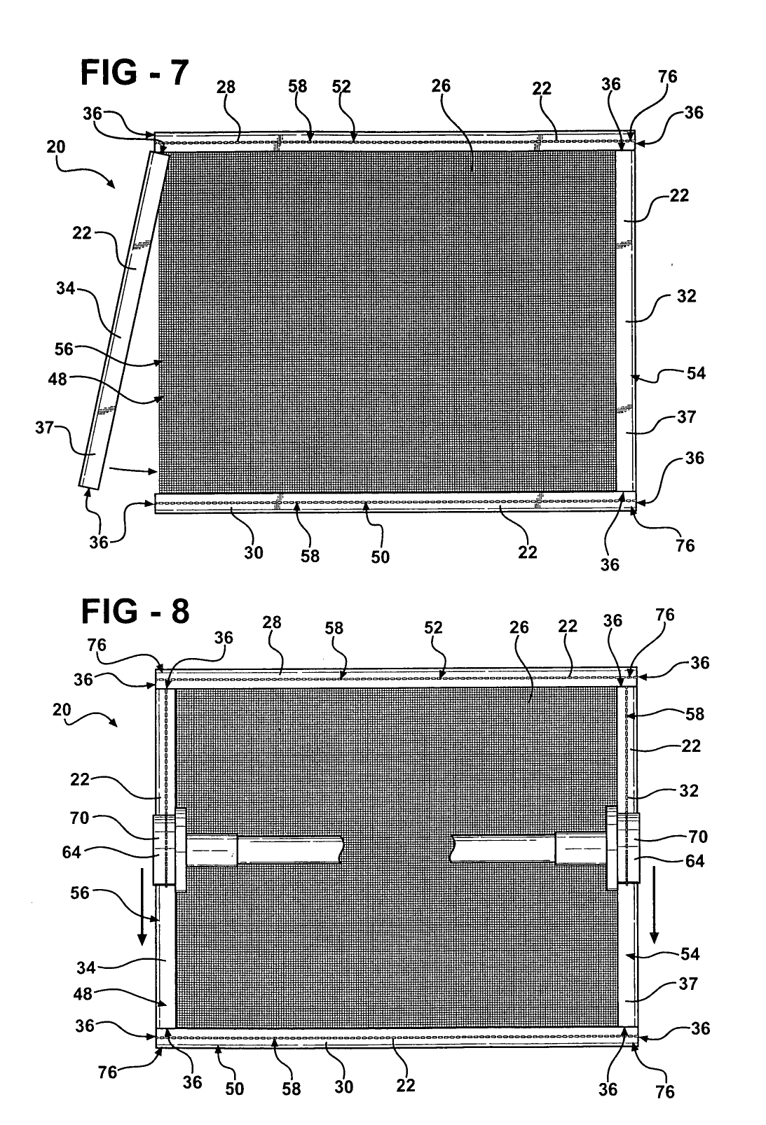

A plurality of spaced dimples 58 are formed along the legs 40, 42 of each of the frame sections 22. A generally planar surface 59 extends 36 between each of the dimples 58 along each of the frame sections 22. The planar surface 59 which provides the spacing between the dimples. This spacing provides contour for the screen cloth 26 to follow as the screen cloth 26 is trapped and retained between the dimples 58 and the first and second legs 40, 42 of the frame sections 22. A first plurality of spaced dimples 60 are formed along the first leg 40 and a second plurality of spaced dimples 62 are formed along the second leg 42. The first plurality of dimples 60 extend into the slot 57 of each of the frame sections 22, engaging the cloth and trapping the screen cloth 26 between the dimple of the first leg 40 and the second leg 42 to retain the screen cloth 26 to the frame sections 22. The first plurality of dimples 60 are complimentary and nest within each of the corresponding second plurality of dimples 62. The first plurality of dimples 60 extend into the slot 57 and the second plurality of dimples 62 extend away from the slot 57. This means that the first dimples 60, which are in the slot 57, include a first width W1 and the second dimples 62, which extend away from the slot 57, include a second width W2 larger than the first width W1. This means that the first width W1 of the first dimples 60 extend into and nest within the second width W2 of the second dimples 62. The screen cloth 26 follows the contour between the first and second dimples 60, 62, engaging and trapping the screen cloth 26 to retain the screen cloth 26 to the frame sections 22. The dimples 58 may be any desired shape. For example, referring to FIGS. 4a and 5a, the dimples 58 may be cubic. This means that when the frame section 22 viewed from the top, in FIG. 4a, and viewed from the side, in FIG. 5a, the dimples 58 have a generally square shape. Referring to FIGS. 4b and 5b, the dimples 58 may be semi-spherical. This means that when the frame section 22 is viewed from the top, in FIG. 4b, the dimples are generally circular. When the frame section 22 is viewed from the side, in FIG. 5b, the dimples are generally shaped as half of a circle. However, the dimples 58 are not limited to being these shapes and may be any desired shape, or grouping of a variety of desired shapes. As an example, the dimples 58 may be a pattern which includes both cubic and semi-spherical dimples 58 formed along the same frame section 22.

Additionally, the first and second plurality of dimples 60, 62 may alternate or vary the direction they are formed in the first and second legs 42 of the frame sections 22. While the first plurality of dimples 60 are complimentary and nest within each of the second plurality of dimples 62, one pair of first and second dimples 60, 62 would have the first plurality of dimples 60 extending into the slot 57 and the second plurality of dimples 62 extending away from the slot 57. A next pair of dimples 58, on the same frame section, would have the first plurality of dimples 60 extending away from the slot 57 and the second plurality of dimples 62 extending into the slot 57.

Alternatively, the first plurality of dimples 60 are offset and in opposition to the second plurality of dimples 62. The first plurality of dimples 60 and the second plurality of dimples 62 extend into the slot 57 and the screen cloth 26 follows the contour of the dimples 58, engaging and trapping the screen cloth 26 to retain the screen cloth 26 to the frame sections 22.

The screen cloth 26, i.e., screen, is disposed between the first and the second legs 40, 42 of the frame section 22 to cover the opening 24 and prevent the ingress of insects or debris, for example, while providing ventilation through the opening 24. The screen cloth 26 is preferably formed from fiberglass and coated with polyvinylchloride (PVC). However, the screen cloth 26 can be formed from other types of material as well (e.g. aluminum, stainless steel, etc.) and a coating is not necessarily required. Additionally, the screen cloth 26 does not have to be a “cloth”. For example, the screen cloth 26 can appear solid with minute holes or the screen cloth 26 can be a solid sheet of material. The only requirement is that the screen cloth 26 deforms and follows the contour of the dimples 58 formed in the first and second legs 42 of the frame sections 22. Additionally, the screen cloth 26 can be cut to any preferred size and shape.

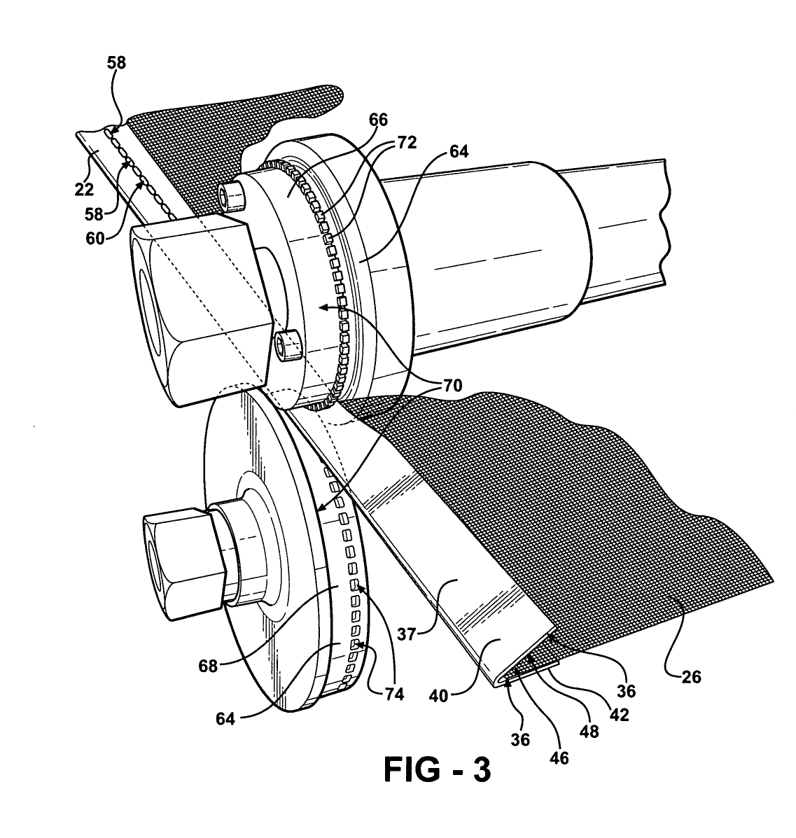

Referring generally to FIGS. 3, 9, and 10, the dimples 58 are typically formed using locking rolls 64. Locking rolls 64 include a first wheel 66 and a second wheel 68. The first wheel 66 presents a circumferential edge 70 extending around a circumference of the first wheel 66. The first wheel 66 defines a plurality of protrusions 72, spaced around the circumferential edge 70 of the first wheel 66. Similarly, the second wheel 68 presents a circumferential edge 70 extending around a circumference of the second wheel 68. The second wheel 68 includes a plurality of craters 74, spaced around the circumferential edge 70 of the second wheel 68. The first wheel 66 is generally parallel to the second wheel 68 with the circumferential edge 70 of each of the wheels spaced a sufficient distance to allow the first and second legs 42 and the screen cloth 26 to pass therebetween when the first leg 40 is collapsed onto the second leg 42. The protrusions 72 of the first wheel 66 are generally opposed to the craters 74 of the second wheel 68. The first wheel 66 and second wheel 68 counter rotate, meaning they rotate in opposing directions, such that the protrusions 72 of the first wheel 66 mesh with and enter the craters 74 of the second wheel 68 as the wheels counter rotate. It can be appreciated that the protrusions 72 and craters 74 are not limited to the configuration described above. For example, the first wheel 66 and the second wheel 68 may have alternating craters 74 and protrusions 72 spaced around the circumferential edge 70. Each crater 74 and protrusion 72 meshes with a corresponding protrusion 72 and crater 74 as the wheels 66, 68 counter rotate.

The protrusions 72 mesh with the craters 74 as the strip of material 38 is passed between the first and second wheels 68 to form the plurality of spaced dimples 58 along the frame section 22. If the strip of material 38 has already been folded upon itself to define the cavity 46, and the first edge 50 of the screen cloth 26 is disposed in the cavity 46, both legs of the strip of material 38 are passed between the first and second wheel 66, 68, along with the first edge 50 of the screen cloth 26, where the first leg 40 is collapsed onto the second leg 42 to define the slot 57 therebetween and form the plurality of dimples 58. Prior to passing the strip of material 38 between the first and second wheel 68, the edge of the screen cloth 26 is disposed in the cavity 46. Therefore, the first leg 40 is collapsed onto the second leg 42 simultaneous with passing the frame section 22 and the edge of the screen cloth 26 between the locking rolls 64. The edge of the screen cloth 26 is typically deformed and follows the contour of the dimples 58 between the first and second legs 40, 42 so that the edge of the screen cloth 26 becomes trapped and retained between the first and second legs 40, 42 by the dimples 58. This means that the screen cloth 26 may be retained to the screen frame by only the dimples 58. It is not required, however, that the first leg 40 is collapsed onto the second leg 42 simultaneous with forming the dimples 58 along the frame section. The first leg 40 may be collapsed onto the second leg 42 while passing the strip of material 38 through a first set of locking rolls 64 and the dimples 58 may be formed along the frame section 22 while passing the frame section 22 and the screen cloth 26 through a second set of locking rolls 64.

The order the frame sections 22 are attached to the edges 48 of the screen cloth 26 can vary. This means that the frame sections 22 with the corresponding edge 48 of the screen cloth 26 may be passed between the locking rolls 64 on an individual basis. However, the frame sections 22 may also be passed between the locking rolls 64 simultaneously, e.g., in parallel frame sections 22, perpendicular adjacent frame sections 22, all frame sections 22 simultaneously, etc.

The second frame section 30 includes a first leg 40 and a second leg 42 with the first and second legs 40, 42 defining a cavity 46 therebetween. The second edge 52 of the screen cloth 26 is disposed in the cavity 46 of the second frame section 30. The second frame section 30 is collapsed onto the second edge 52 of the screen cloth 26. A plurality of dimples 58 are formed in the collapsed second frame section 30 in spaced relationship to retain the screen cloth 26 to the second frame section 30. The second edge 52 of the screen cloth 26 is typically opposite, i.e., parallel, the first edge 50 of the screen cloth 26. This allows for the use of two sets of locking rolls 64 which may operate simultaneously, as shown in FIG. 6. If the locking rolls 64 operate simultaneously, the first leg 40 is collapsed onto the second leg 42 of each of the first and the second frame sections 28, 30 while forming a plurality of dimples 58 along each of the first and second frame sections 28, 30 to trap and retain the screen cloth 26. When the first and the second frame sections 28, 30 are attached to the first and second edges 50, 52 of the screen cloth 26, the first and second frame sections 28, 30 may be drawn slightly apart to stretch, or tension, the screen cloth 26 prior to attaching any of the third and the fourth frame sections 32, 34 to the screen cloth 26. The resulting tension in the screen assembly 20 helps to draw the frame sections 22 toward the screen cloth 26, forming a frame assembly 20 such that the frame sections 22 are drawn tightly together and the screen cloth 26 does not sag.

The third frame section 32 includes a first leg 40 and a second leg 42 with the first and second legs 40, 42 defining a cavity 46 therebetween. The third edge 54 of the screen cloth 26 is placed in the cavity 46 of the third frame section 32. The third edge 54 is perpendicular to the first and the second edges 50, 52. The first leg 40 is collapsed onto the second leg 42 and the screen cloth 26. A plurality of spaced dimples 58 are formed along the first leg 40 to retain the screen cloth 26 to the third frame section 32. It should be appreciated that the third frame section 32 may be attached to the third edge 54 of the screen cloth 26 prior to, after, or simultaneous with the attachment of any other frame sections 22 to their respective edges 48. It should be appreciated that the simultaneous use of multiple sets of locking rolls 64 is not limited to operating in parallel. For example, the sets of locking rolls 64 may operate on adjacent frame sections 22 such that the first and third frame sections 28, 32, which may extend perpendicular to one another.

The fourth frame section 34 includes a first leg 40 and a second leg 42 with the first and second legs 40, 42 defining a cavity 46 therebetween. The fourth edge 58 of the screen cloth 26 is placed in the cavity 46 of the fourth frame section 34. The fourth edge 56 is perpendicular to the first and the second edges 50, 52. The first leg 40 is collapsed onto the second leg 42 and the screen cloth 26. A plurality of spaced dimples 58 are formed along the first leg 40 to retain the screen cloth 26 to the fourth frame section 34. It should also be appreciated that the sets of locking rolls 64 are not limited to only operating on one or two frame sections 22 simultaneously, but any number of sets of locking rolls 64 may be used simultaneously.

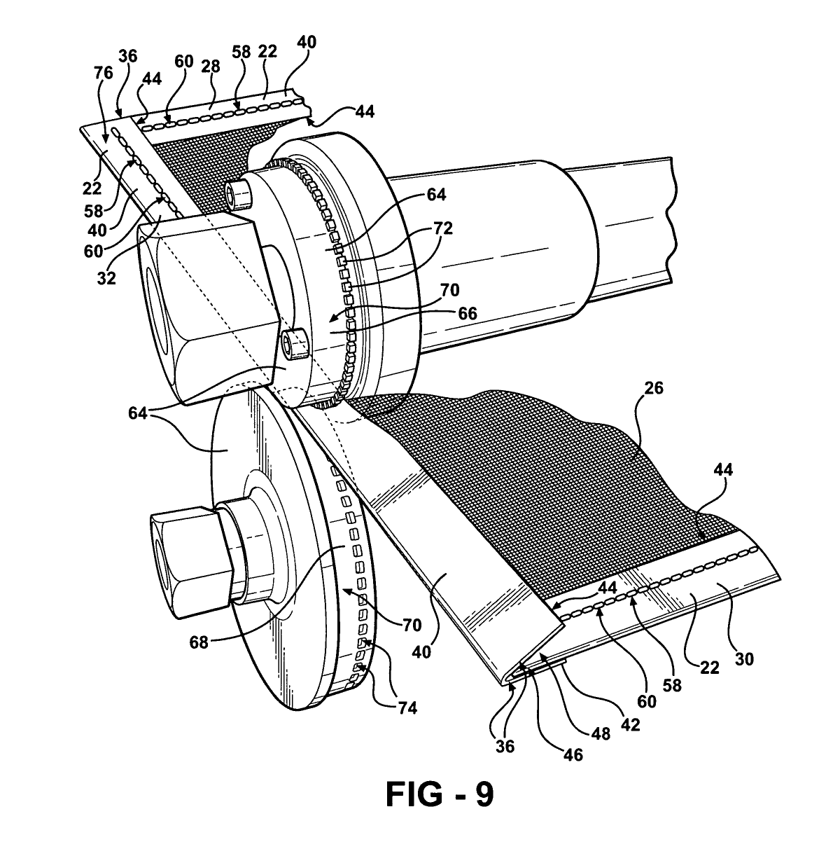

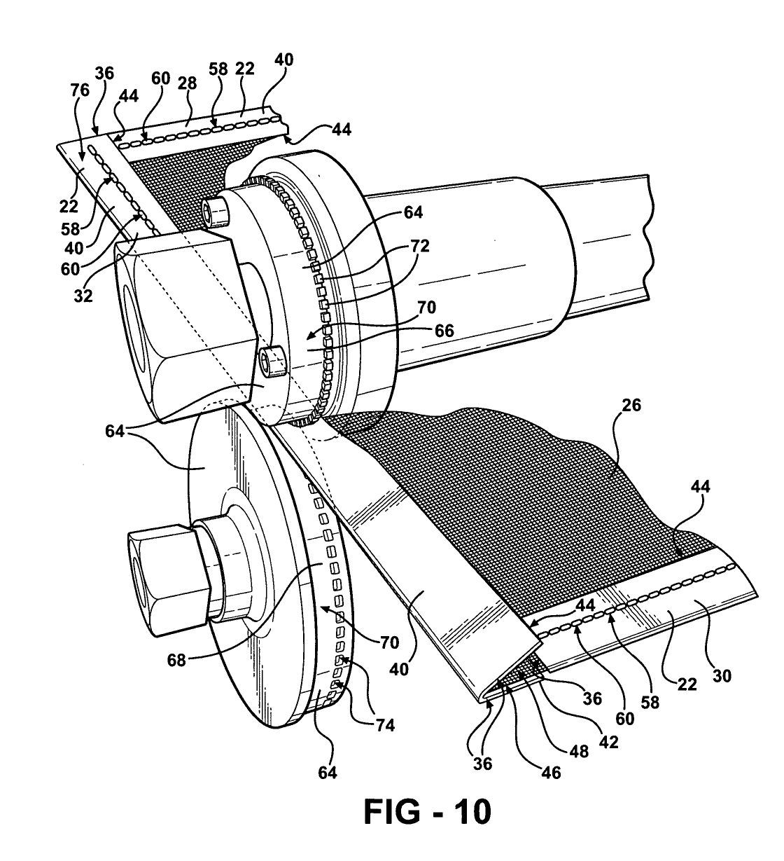

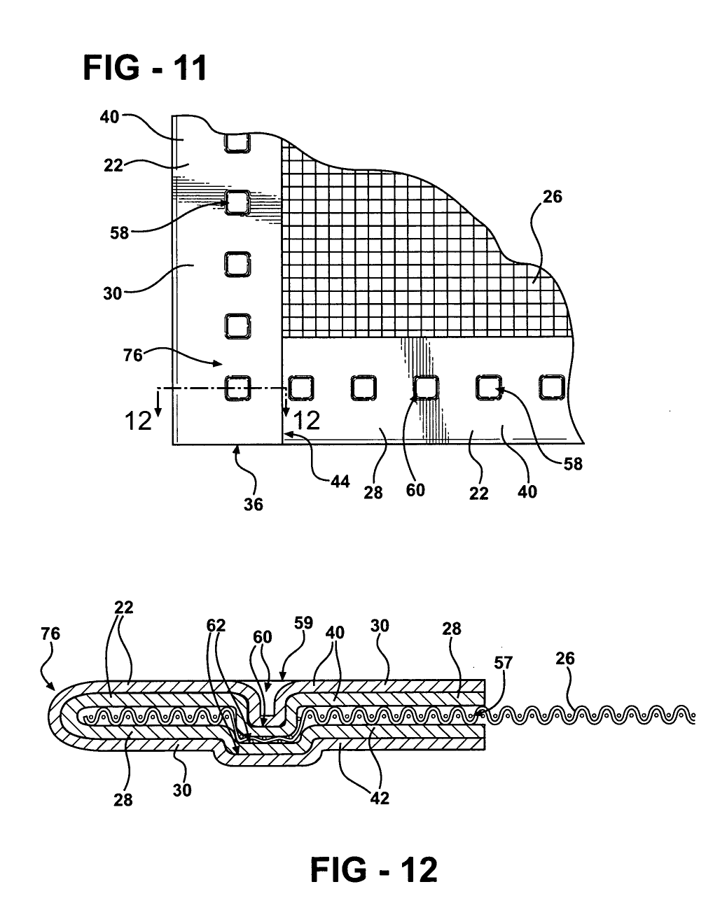

After assembly, the screen assembly 20 maintains its shape by virtue of corners 76, referring generally to FIG. 1. A corner 76 is defined between each pair of adjacent frame sections, for example, between the first and third frame section 32 as shown in FIG. 11. Referring to FIGS. 9, 11, and 12, the corners 76 of the screen assembly 20 may be formed by inserting the end 36 of one of the frame sections 22 in the cavity 46 of the adjacent frame section, prior to passing the adjacent frame section between the locking rolls 64. For example, referring again to FIG. 11, one of the ends 36 of the first frame section 28 is inserted into the cavity 46 of the third frame section 32. As the first leg 40 is collapsed onto the second leg 42 of the third frame section 32 the dimples 58 are formed through the first leg 40 of each of the first and third frame sections 28, 32, and the second leg 42 of each of the first and third frame sections 28, 32 at the corner 76, as shown in FIG. 12. The edges 48 of the screen cloth 26 and the end 36 of the first frame section 28 are trapped and retained by the third frame section 32. This results in a robust corner 76 which gives the screen assembly 20 rigidity. Alternatively, referring to FIG. 10, the corners 76 may be formed by abutting one of the ends 36 of the first frame section 28 against the margin 44 of the adjacent third frame section 32 to form a butt-joint therebetween. However, the corners 76 are not limited to being formed in this way and may be formed using any desired method.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A screen assembly for a window or a door, said assembly comprising;
a plurality of frame sections defining an opening,
each of said frame sections formed from a strip of material with said strip of material folded upon itself to include a first leg and a second leg adjacent said first leg with said legs defining a slot therebetween,
a screen cloth disposed in said slot of each of said frame sections and extending across said opening 24 between said frame sections, and
a plurality of spaced dimples formed in said first legs of each of said frame sections with said dimples extending into said slot of each of said frame sections engaging said cloth and trapping said screen cloth between said dimple of said first leg and said second leg to retain said screen cloth to said frame sections.

2. A screen assembly as set forth in claim 1 wherein said plurality of dimples are further defined as being formed along said first leg and said second leg to retain said screen cloth to each of said frame sections.

3. A screen assembly as set forth in claim 1 wherein said dimples are further defined as a first plurality of spaced dimples formed along said first leg and further including a second plurality of dimples formed along said second leg engaging and trapping said screen cloth to retain said screen cloth to said frame sections.

4. A screen assembly as set forth in claim 3 wherein said first plurality of dimples are complimentary and nest within said corresponding second plurality of dimples with said first plurality of dimples extending into said slot and said second plurality of dimples extending away from said slot and said screen cloth following said contour of said dimples engaging and trapping said screen cloth to retain said screen cloth to said frame sections.

5. A screen assembly as set forth in claim 4 wherein said first dimples are further defined as including a first width and said second dimples are further defined as including a second width larger than said first width with said first width of said first dimple nesting within said second width of said second dimple.

6. A screen assembly as set forth in claim 2 wherein said first plurality of dimples are offset and in opposition to said second plurality of dimples with said first plurality of dimples and said second plurality of dimples extending into said slot and said screen cloth following said contour of said dimples engaging and trapping said screen cloth to retain said screen cloth to said frame sections.

7. A screen assembly as set forth in claim 1 wherein said dimples are further defined as semi-spherical.

8. A screen assembly as set forth in claim 1 wherein said dimples are further defined as cubic.

9. A screen assembly as set forth in claim 1 further including a planar surface on said first legs extending between each of said dimples.

10. A screen assembly as set forth in claim 1 wherein each of said frame sections extend between ends with each of said ends disposed in said slot of said adjacent frame section to define a corner therebetween.

11. A screen assembly as set forth in claim 10 wherein said plurality of spaced dimples are further defined as a plurality of spaced dimpled formed in said first legs of each of said frame sections with said dimples extending into said slot of each of said frame sections engaging said cloth and trapping said screen cloth and said end of said adjacent frame section between said dimple of said first leg and said second leg to retain said screen cloth and said adjacent frame section.

12. A screen assembly as set forth in claim 1 wherein each of said frame sections extend between ends and each of said first and second legs extending along a margin with said ends of each of said frame sections abutting said margin of said adjacent frame section to define a corner therebetween.

13. A method of attaching a screen cloth to a frame section including a first leg and a second leg with the first and second leg defining a cavity therebetween, said method comprising the steps of;
placing an edge of the screen cloth in the cavity of the frame section,
collapsing the first leg onto the second leg to define a slot therebetween, and
forming a plurality of spaced dimples in the first leg to retain the screen cloth to the frame section.

14. A method as set forth in claim 13 wherein said step of forming a plurality of dimples is further defined as forming a plurality of dimples through the first and the second legs.

15. A method as set forth in claim 13 further comprising the step of rotating at least one locking roll.

16. A method as set forth in claim 15 wherein said step of rotating at least one locking roll is further defined as counter-rotating a pair of locking rolls with respect to one another.

17. A method as set forth in claim 13 further comprising the step of passing the frame section and the screen cloth between the set of counter-rotating locking rolls.

18. A method as set forth in claim 14 wherein said steps of collapsing the first leg onto the second leg occurs simultaneous to said step of passing the frame section and the edge of the screen cloth between the locking rolls.

19. A method as set forth in claim 17 wherein said step of counter-rotating the locking rolls is further defined as meshing the locking rolls to form dimples in the frame section.

20. A method as set forth in claim 13 further including a second frame section 30 including a first leg and a second leg with the first and second legs defining a cavity therebetween, said method further comprising the steps of:
placing a second edge of the screen cloth in the cavity of the second frame section,
collapsing the second frame section onto the second edge of the screen cloth, and
forming a plurality of spaced dimples along the collapsed second frame section to retain the screen cloth to the second frame section.

21. A method as set forth in claim 20 further including the step of collapsing the first and the second frame sections simultaneously.

22. A method as set forth in claim 20 further including the step of forming a plurality of dimples along the first and the second frame sections simultaneously.

23. A method as set forth in claim 20 wherein the second edge of the screen cloth is parallel to the first edge of the screen cloth with the second frame section placed parallel to the first frame section.

24. A method as set forth in claim 23 further comprising the step of stretching the screen cloth between the first and the second frame sections.

25. A method as set forth in claim 24 further including a third frame section including a first leg and a second leg with the first and second legs defining a cavity therebetween, said method further comprising the steps of:
placing a third edge of the screen cloth in the cavity of the third frame section with the third edge being perpendicular to the first and the second edges,
collapsing the first leg onto the second leg to define a slot therebetween, and
forming a plurality of spaced dimples along the first leg to retain the screen cloth to the third frame section.

26. A method as set forth in claim 13 further including a third frame section including a first leg and a second leg with the first and second legs defining a cavity therebetween, said method further comprising the steps of:
placing a third edge of the screen cloth in the cavity of the third frame section with the third edge being perpendicular to the first edge,
collapsing the first leg onto the second leg to define a slot therebetween, and
forming a plurality of spaced dimples along the first leg to retain the screen cloth to the third frame section.

27. A method as set forth in claim 26 wherein each of the first and the third frame sections extend between ends, said method further comprising the steps of:
placing one of the ends of the first frame section into cavity of the third frame section, and
collapsing the first leg onto the second leg of the third frame section to form a corner therebetween.

28. A method as set forth in claim 27 further including the step of forming a plurality of spaced dimples in the first leg of the each of the first and the third frame sections in the corner with the dimples of the first frame section nesting within the dimples of the third frame section.

29. A method as set forth in claim 28 wherein said step of forming a plurality of dimples in the corner is further defined as forming a plurality of dimples through the first and second legs of each of the first and third frame sections in the corner.

30. A method as set forth in claim 26 wherein each of the first and the first frame sections extend between ends and each of the first and second legs extend along a respective margin, said method further comprising the step of abutting an end of one of the first and third frame sections with the margins of the other of the first and third frame sections to define a corner therebetween.
